(19) United States
(12) Patent Application Publication
(10) Pub. No.: US 2008/0040110 A1
(43) Pub. Date: Feb. 14, 2008

(54) Apparatus and Methods for the Detection of Emotions in Audio Interactions

(75) Inventors: Oren Pereg, Zikhron Ya'akov (IL); Moshe Wasserblat, Modiin (IL)

Correspondence Address: Mark Soffer;Gary Kain, 14 Shenkar Street, 14 Shenkar Street, Herzliya Pituach, 47725, omitted

(73) Assignee: NICE SYSTEMS LTD., Raanana (IL)

(21) Appl. No.: 11/568,048

(22) PCT Filed: Aug. 8, 2005
(86) PCT No.: PCT/IL05/00848

§ 371 Date: Mar. 14, 2007

(51) Int. Cl. G10L 15/02

(52) U.S. Cl. 704/236; 704/E15.014

(57) ABSTRACT

An apparatus and method for detecting an emotional state of a speaker participating in an audio signal. The apparatus and method are based on the distance in voice features between a person being in an emotional state and the same person being in a neutral state. The apparatus and method comprise a training phase in which a training feature vector is determined, and an ongoing stage in which the training feature vector is used to determine emotional states in a working environment. Multiple types of emotions can be detected, and the method and apparatus are speaker-independent, i.e., no prior voice sample or information about the speaker is required.

### BACKGROUND OF THE INVENTION

1. Field of the Invention

The present invention relates to audio analysis in general, and to an apparatus and methods for the automatic detection of emotions in audio interactions, in particular.

2. Discussion of the Related Art

Audio analysis refers to the extraction of information and meaning from audio signals for purposes such as statistics, trend analysis, quality assurance, and the like. Audio analysis could be performed in audio interaction-extensive working environments, such as for example call centers, financial institutions, health organization, public safety organizations or the like, in order to extract useful information associated with or embedded within captured or recorded audio signals carrying interactions, such as phone conversations, interactions captured from voice over IP lines, microphones or the like. Audio interactions contain valuable information that can provide enterprises with insights into their users, customers, activities, business and the like. The extracted information can be used for issuing alerts, generating reports, sending feedback or otherwise using the extracted information. The information can be stored, retrieved, synthesized, combined with additional sources of information and so on. A highly required capability of audio analysis systems is the identification of interactions, in which the customers or other people communicating with an organization, achieve a highly emotional state during the interaction. Such emotional state can be anger, irritation, laughter, joy or other negative or positive emotions. The early detection of such interactions would enable the organization to react effectively and to control or contain damages due to unhappy customers in an efficient manner. It is important that the solution will be speaker-independent. Since for most callers no earlier voice characteristics are available to the system, the solution must be able to identify emotional states with high certainty for any speaker, without assuming the existence of additional information. The system should be adaptable to the relevant cultural, professional and other differences between organizations, such the differences between countries, financial or trading services vs. public safety services and the like. The system should also be adaptable to various user requirements, such as detecting all emotional interactions, on the expense of receiving false alarm events, vs. detecting only highly emotional interactions on the expense of mission other emotional interactions. Differences between speakers should also be accounted for. The system should report any high emotional level or classify the instances of emotions presented by the speaker into positive or negative emotions, or further distinguish for example between anger, distress, laughter, amusement, and other emotions.

There is therefore a need for a system and method that would detect emotional interactions with high degree of certainty. The system and method should be speaker-independent and not require additional data or information. The apparatus and method should be fast and efficient, provide results in real-time or near-real time, and account for different environments, languages, cultures, speakers and other differentiating factors.

### SUMMARY OF THE PRESENT INVENTION

It is an object of the present invention to provide a novel method for detecting one or more emotional states of one or more speakers speaking in one or more tested audio signals each having a quality, the method comprising an emotion detection phase, the emotion detection phase comprising: a feature extraction step for extracting two or more feature vectors, each feature vector extracted from one or more frames within one or more tested audio signals; a first model construction step for constructing a reference voice model from two or more first feature vectors, the model representing the speaker's voice in neutral emotional state of the speaker; a second model construction step for constructing one or more section voice models from two or more second feature vectors; a distance determination step for determining one or more distances between the reference voice model and the section voice mode; and a section emotion score determination step for determined, by using the at least one distance, one or more emotion scores. The method can further comprise a global emotion score determination step for detecting one or more emotional states of the speaker speaking in the tested audio signal based on the emotion score. The method can further comprise a training phase, the training phase comprising: a feature extraction step for extracting two or more feature vectors, each features vector extracted from one or more frames within one or more training audio signals each having a quality; a first model construction step for constructing a reference voice model from two or more feature vectors; a second model construction step for constructing one or more section voice models from two or more feature vectors; a distance determination step for determining one or more distances between the reference voice model and the one or more section voice models; and a parameters determination step for determining a trained parameter vector. Within the method, the section emotion scores determination step of the emotion detection phase uses the trained parameter vector determined by the parameters determination step of the training phase. Within the method, the emotion detection phase or the training phase further comprise a front-end processing step for enhancing the quality of one or more tested audio signals or the quality of one or more training audio signals. The front-end processing step can comprise a silence/voiced/unvoiced classification step for segmenting the one or more tested audio signals or the one or more training audio signals into silent, voiced and unvoiced sections. Within the method, the front-end processing step can comprise a speaker segmentation step for segmenting multiple speakers in the tested audio signal or the training audio signal. The front-end processing step can comprise a compression step or a decompression step for compressing or decompressing the one or more tested audio signals or the one or more training audio signals. The method can further associate the one or more emotional states found within the one or more tested audio signals with an emotion.

Another aspect of the present invention relates to an apparatus for detecting an emotional state of one or more speakers speaking in one or more audio signals having a quality, the apparatus comprises: a feature extraction component for extracting at least two feature vectors, each feature vector extracted from one or more frames within the one or more audio signals; a model construction component for constructing a model from two or more feature vectors; a distance determination component for determining a distance between the two models; and an emotion score determination component for determining, using said distance, one or more emotion scores for the one or more speakers within the one or more audio signals to be in an emotional state. The apparatus can further comprises a global emotion score determination component for detecting one or more emotional states of the one or more speakers speaking in the one or more audio signals based on the one or more emotion scores. The apparatus can further comprise a training parameter determination component for determining a trained parameter vector to be used by the emotion score determination component. The apparatus can further comprises a front-end processing component for enhancing the quality of the at least one audio signal. The front-end processing step can comprise a silence/voiced/unvoiced classification component for segmenting the one or more audio signals into silent, voiced, and unvoiced sections. The front-end processing step can further comprise a speaker segmentation component for segmenting multiple speakers in the one or more audio signals, or a compression component or a decompression component for compressing or decompressing the one or more audio signals. Within the apparatus, the emotional state can be associated with an emotion.

Yet another aspect of the present invention relates to a computer readable storage medium containing a set of instructions for a general purpose computer, the set of instructions comprising: a feature extraction component for extracting two or more feature vectors, each feature vector extracted from one or more frames within one or more audio signals in which one or more speakers are speaking; a model construction component for constructing a model from two or more feature vectors; a distance determination component for determining a distance between the two models; and an emotion score determination component for determining, using said distance, one or more emotion scores for the one or more speakers within the one or more audio signals to be in an emotional state.

### BRIEF DESCRIPTION OF THE DRAWINGS

The present invention will be understood and appreciated more fully from the following detailed description taken in conjunction with the drawings in which:

FIG. 1 is a schematic block diagram of the proposed apparatus, within a typical environment, in accordance with the preferred embodiments of the present invention;

FIG. 2 is a flow chart describing the operational steps of the training phase of the method, in accordance with the preferred embodiments of the present invention

FIG. 3 is a flow chart describing the operational steps of the detection phase of the method, in accordance with the preferred embodiments of the present invention;

FIG. 4 is a flow chart describing the operational steps of the front-end preprocessing, in accordance with the preferred embodiments of the present invention; and

FIG. 5 is a block diagram describing the main computing components, in accordance with the preferred embodiments of the present invention.

### DETAILED DESCRIPTION OF THE PREFERRED EMBODIMENT

The disclosed invention presents an effective and efficient emotion detection method and apparatus in audio interactions. The method is based on detecting changes in speech features, where significant changes correlate to highly emotional states of the speaker. The most important features are the pitch and variants thereof, energy, spectral features. During emotional sections of an interaction, these features' statistics are likely to change relatively to neutral periods of speech. The method comprises a training phase, which uses recordings of multiple speakers, in which emotional parts are manually marked. The recording preferably comprise a representative sample of speakers typically interacting with the environment. The training phase output is a trained parameters vector that conveys the parameters to be used during the ongoing emotion detection phase. Each parameter in the trained parameters vector represents the weight of one voice feature, i.e., the level in which this voice feature is changed between sections of non-emotional speech and sections of emotional speech. In case of multiple emotions classification a dedicated trained parameters vector is determined for each emotion. Thus, the training parameter vector connects between the segments within the interaction being neutral or emotional, and the differences in characteristics exhibited by speakers when speaking in neutral state and in emotional state.

Once the training phase is completed, the system is ready for the on-going phase. During the ongoing phase, the method first performs an initial learning step, during which voice features from specific sections of the recording are extracted and a statistical model of those features is constructed. The statistical model of voice features is representing “neutral” state of the speaker and will be referred as the reference voice model. Features are extracted from frames, representing the audio signal over 10 to 50 milliseconds. Preferably, the frames from which the features are extracted are at the beginning of the conversation, when the speaker is usually assumed to be calm. Then, voice feature vectors are extracted from multiple frames throughout the recording. A statistical voice model is constructed from every group of feature vectors extracted from consecutive overlapping frames. Thus, each voice model represents a section of a predetermined length of consecutive speech and is referred to as the section voice model. A distance vector between each model representing the voice in one section and the reference voice model is determined using a distance function. In order to determine the emotional score of each section a scoring function is introduced. The scoring function uses the weights determined at the training phase. Each score represents the probability for emotional speech in the corresponding section, based on the difference between the model of the section and the reference model. The assumption behind the method is that even in an emotional interaction there are sections of neutral (calm) speech (e.g., at the beginning or end of an interaction) that can be used for building the reference voice model of the speaker. Since the method measures the differences between the reference voice model and every section's voice model, it thus automatically normalizes the specific voice characteristics of the speaker and provides a speaker-independent method and apparatus. If the initial training is related to multiple types of emotions, multiple scores are determined for each section using the multiple trained parameter vectors based on the same voice models mentioned above, thus evaluating the probability score for each emotion. The results can be further correlated with specific emotional events, such as laughter which can be recognized with high certainty. Laughter detection can assist in distinguishing positive and negative emotions. The detected emotional parts can further be correlated with additional data, such as emotions-expressing spotted words, CTI data or the like, thus enhancing the certainty of the results.

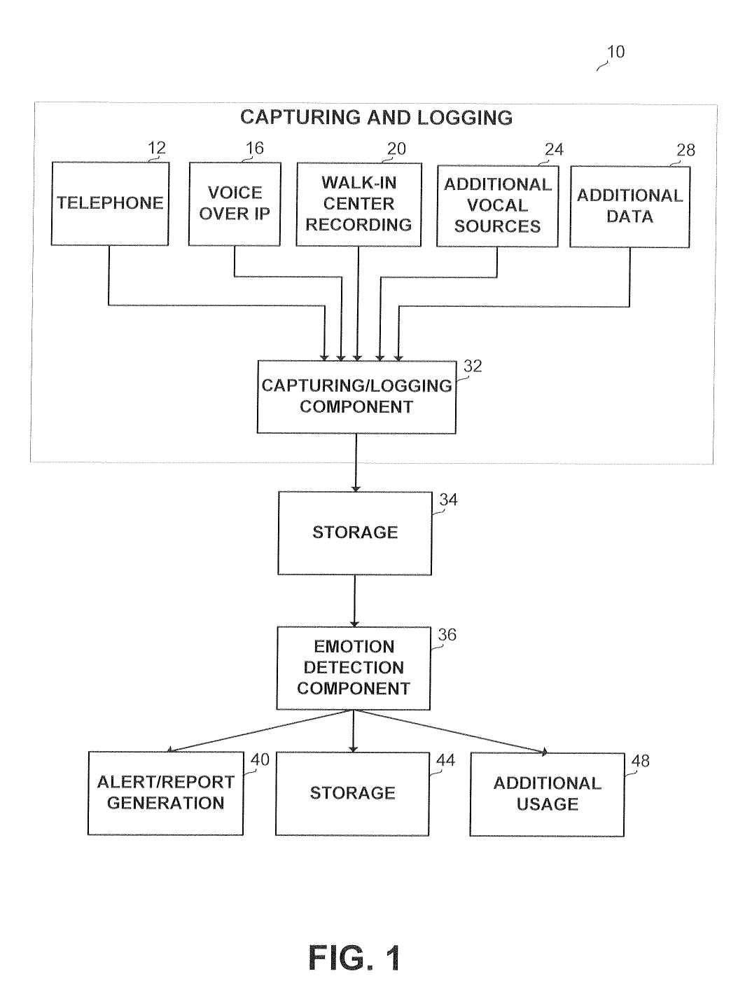

Referring now to FIG. 1, which presents a block diagram of the main components in a typical environment in which the disclosed invention is used. The environment, generally referenced as 10, is an audio-interaction-rich organization, typically a call center, a bank, a trading floor, another financial institute, a public safety contact center, or the like. Customers, users, or other contacts are contacting the center, thus generating input information of various types. The information types include vocal interactions, non-vocal interactions and additional data. The capturing of voice interactions can employ many forms and technologies, including trunk side, extension side, summed audio, separated audio, various encoding methods such as G729, G726, G723.1, and the like. The vocal interactions usually include telephone 12, which is currently the main channel for communicating with users in many organizations. The voice typically passes through a PABX (not shown), which in addition to the voices of the two or more sides participating in the interaction collects additional information discussed below. A typical environment can further comprise voice over IP channels 16, which possible pass through a voice over IP server (not shown). The interactions can further include face-to-face interactions, such as those recorded in a walk-in-center 20, and additional sources of vocal data 24, such as microphone, intercom, the audio part of video capturing, vocal input by external systems or any other source. In addition, the environment comprises additional non-vocal data of various types 28. For example, Computer Telephone Integration (CTI) used in capturing the telephone calls, can track and provide data such as number and length of hold periods, transfer events, number called, number called from, DNIS, VDN, ANI, or the like. Additional data can arrive from external sources such as billing, CRM, or screen events, including demographic data related to the customer, text entered by a call representative, documents and the like. The data can include links to additional interactions in which one of the speakers in the current interaction participated. Data from all the above-mentioned sources and others is captured and preferably logged by capturing/logging unit 32. The captured data is stored in storage 34, comprising one or more magnetic tape, a magnetic disc, an optical disc, a laser disc, a mass-storage device, or the like. The storage can be common or separate for different types of captured interactions and different types of additional data. Alternatively, the storage can be remote from the site of capturing and can serve one or more site of multi-site organization such as a bank. Capturing/logging unit 32 comprises a computing platform running one or more computer applications as is detailed below. From capturing/logging unit 32, the vocal data and preferably the additional relevant data are transferred to emotion detection component 36 which detects the emotion in the audio interaction. It is obvious that if the audio content of interactions, or some of the interactions, is recorded as summed, then speaker segmentation has to be performed prior to detecting emotion within the recording. Details about The detected emotional recordings are preferably transferred to alert/report generation component 40. Component 40 generates an alert for highly emotional recordings. Alternatively, a report related to the emotional recordings is created, updates, or sent to a user, such as a supervisor, a compliance officer or the like. Alternatively, the information is transferred for storage purposes 44. In addition, the information can be transferred to any other purpose or component 48, such as playback, in which the highly emotional parts are marked so that a user can skip directly to these segments instead of listening to the whole interaction. All components of the system, including capturing/logging components 32 and emotion detection component 36, preferably comprise one or more computing platforms, such as a personal computer, a mainframe computer, or any other type of computing platform that is provisioned with a memory device (not shown), a CPU or microprocessor device, and several I/O ports (not shown). Alternatively, each component can be a DSP chip, an ASIC device storing the commands and data necessary to execute the methods of the present invention, or the like. Each component can further include a storage device (not shown), storing the relevant applications and data required for processing. Each component of each application running on each computing platform, such as the capturing applications or the emotion detection application is a set of logically inter-related computer programs, modules, or libraries and associated data structures that interact to perform one or more specific tasks. All components of the applications can be co-located and run on the same one or more computing platform, or on different platforms. In yet another alterative, the information sources and capturing platforms can be located on each site of a multi-site organization, and one or more emotion detection components can be possible remotely located, processing interactions captured at one or more sites and storing the results in a local, central, distributed or any other storage. In another preferred alternative, the emotion detection application can be implemented as a web service, wherein the detection is performed by a third-party server, and accessed through the internet by clients supplying audio recording. Any other combination of components, either as a standalone apparatus, an apparatus integrated with an environment, a client-server implementation, or the like, which is currently known or that will become known in the future can be employed to perform the objects of the disclosed invention.

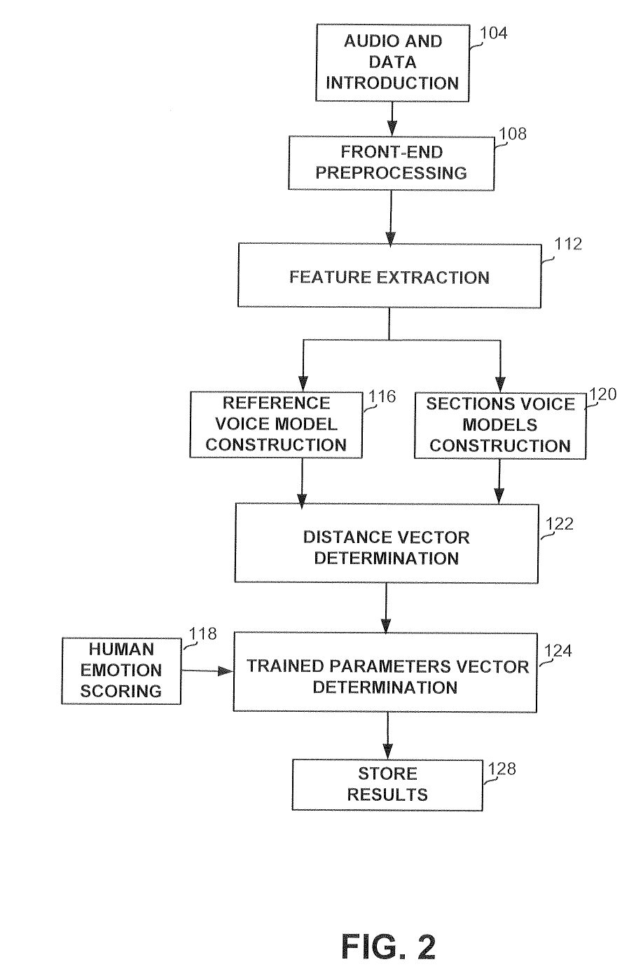

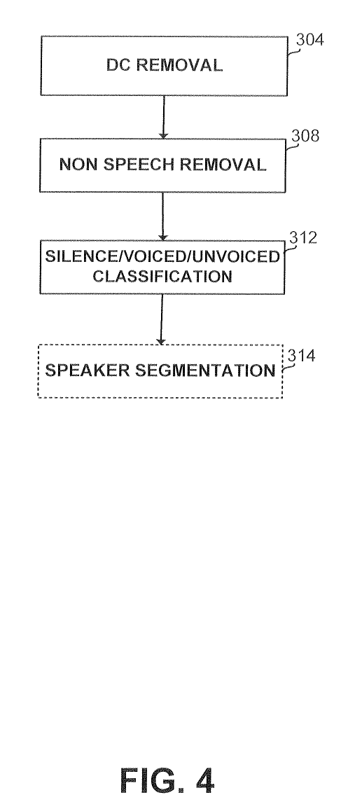

Referring now to FIG. 2, showing a flowchart of the main steps in the training phase of the emotion detection method. Training audio data, i.e., audio signals captured from the working environment and produced using the working equipment, as well as additional data, such as CTI data, screen events, spotted words, data from external sources such as CRM, billing, or the like are introduced at step 104 of the system. The audio training data is preferably collected such that multiple speakers who constitute as representative as possible sample of the population calling the environment participate in the capture interactions. Preferably, the sections are between 0.5 and 10 seconds long. The emotion levels are as determined by one or more human operations. The audio signals can use any format and any compression method acceptable by the system, such as PCM, MP3, G729, G723.1, or the like. The audio can be introduced in streams, files, or the like. At step 108, front-end preprocessing is performed on the audio, in order to enhance the audio for further processing. The front-end preprocessing is further detailed in association with FIG. 4 below. At step 112, voice features are extracted from the audio, thus generating a multiplicity of feature vectors. The voice feature vectors from the entire recording are sectioned, into preferably overlapping sections, each section representing between 0.5 and 10 seconds of speech. The extracted features can be all of the following parameters, any sub-set thereof, or include additional parameters: pitch; energy; LPC coefficients; energy; jitter—pitch tremor (obtained by counting the number of changes in the sign of the pitch derivative in a time window); shimmer (obtained by counting the number of changes in the sign of the energy derivative in a time window); or speech rate (estimated by the number of voiced bursts in a time window). At step 116 voice feature vectors from specific sections of the recording (e.g. beginning of the recording, end of the recording, the entire recording, or any section combination) are grouped together, and a reference voice model is constructed, the model representing the speaker's voice in neutral (calm) state. The statistical model of the features can be GMM (Gaussian Mixture Model) or the like. Since the model is statistical, at least two feature vectors are required for the constriction of the model.

At step 120 the voice feature vectors extracted from the entire recording are sectioned into preferably overlapping sections, each section representing between 0.5 and 10 seconds of speech. A statistical model is than constructed for each section, using the section's feature vectors.

Then at step 122, a distance vector is determined between the reference voice model and the voice model of each section in the recording. Each such distance represents the deviation of the emotional state model from the neutral state model of the speaker. The distance between the voice models may be determined using Euclidean distance function, Mahalanobis distance, or any other distance function.

At step 118, information regarding the emotional type or level of each section in each recording is supplied. The information is generated prior to the training phase by one or more human operators who listen to the signals. At step 124 the distance vectors determined at step 122, with the corresponding human emotion scorings for the relevant recordings from step 118 are used to determine the trained parameters vector. The trained parameter vector is determined, such that the activating its parameters on the distance vectors will provide as close as possible result to the human reported emotional level. There are several preferred embodiments for training the parameters, including but not limited to least squares, weighted least squares, neural networks and SVM. For example, if the method uses the weighted least squares algorithm, then the trained parameters vector is a single set of weight wᵢ such that for each section in each recording, having distance values α₁ . . . α_{N}, where N is the model order,

$${\sum }_{i = 1}^{N} {w}_{i} {a}_{i}$$

is as close as possible to the emotional level assigned by the user. If the system is to distinguish between multiple emotion types, a dedicated trained parameters vector is determined for each emotion type. Since the trained parameters vector was determined by using distance vectors of multiple speakers, it is speaker-independent and relates to the distances exhibited by speakers in neutral state and in emotional state. At step 128 the trained parameters vector is stored for usage during the ongoing emotion detection phase.

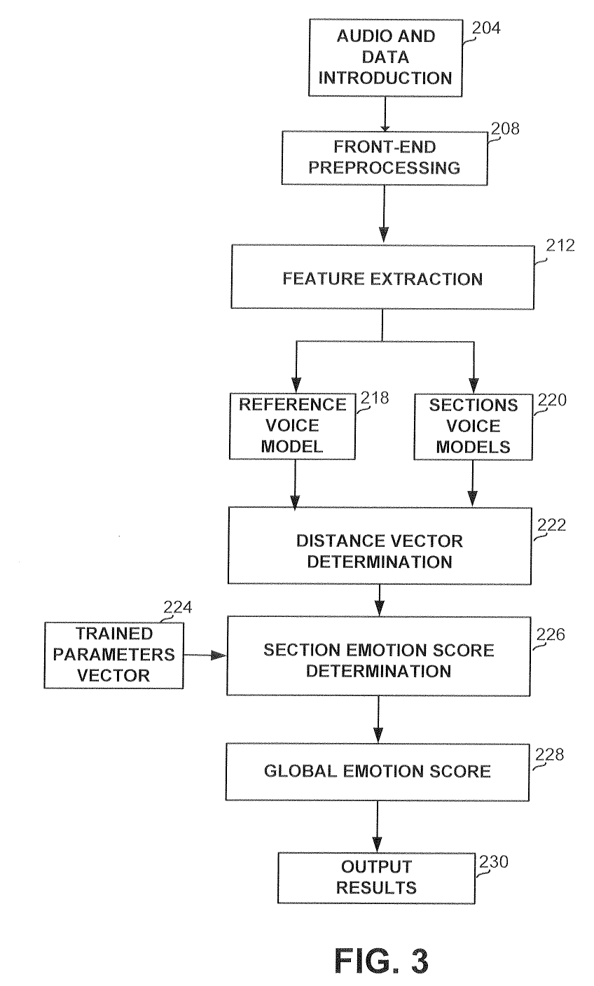

Referring now to FIG. 3, showing a flowchart of the main steps in the ongoing emotion detection phase of the emotion detection method. The audio data, i.e., the captured signals, as well as additional data, such as CTI data, screen events, spotted words, data from external sources such as CRM, billing, or the like are introduced at step 204 to the system. The audio can use any format and any compression method acceptable buy the system, such as PCM, MP3, G729, G726, G723.1or the like. The audio can be introduced in streams, files, or the like. At step 208, front-end preprocessing is performed on the audio, in order to enhance the audio for further processing. The front-end preprocessing is further detailed in association with FIG. 4 below. At step 212, voice features are extracted from the audio, in substantially the same manner as in step 112 of FIG. 2. At step 218 voice feature vectors from specific sections of the recording are grouped together, and a reference voice model is constructed, in substantially the same manner as step 116 of FIG. 2. At step 220 the voice feature vectors extracted from the entire recording are sectioned into preferably overlapping sections that represent between 0.5 and 10 seconds of speech. A statistical model is than constructed for each section, using the section's feature vectors. Then at step 222, a distance vector is determined between the reference voice model and the voice model of each section in the recording, substantially as performed at step 122 of FIG. 2.

At step 224, the trained parameters vector determined at step 124 of FIG. 2 is retrieved, and at step 226 the emotion score for each section is determined using the distance determined at step 222 between the reference voice model and the section's voice model, and the trained parameters vector. The section's score represents the probability that the speech within the section is conveying an emotional state of the speaker. The section score is preferably between 0, representing low probability and 100 representing high probability for emotional section. If the system is to distinguish between multiple emotion types, a dedicated section score is determined based on a dedicated trained parameters vector for every emotion type. The score determination method relates to the method employed at the trained parameters vector determination step 124 of FIG. 2. For example, when parameter determination step 124 of FIG. 2 uses weighted least square, the trained parameter vector is a weights vector, and section emotion score determination step 226 of FIG. 3 should use the same method with the determined weights. At step 228 a global emotion score is determined for the entire audio recording. The score is based on the section's scores within the analyzed recording. The global score determination can use one or more thresholds, such as a minimal number of section scores with probability exceeding a predefined probability threshold, minimum number of consecutive section clusters, or the like. For example, the determination can consider only these interactions in which there were at least X emotional sections, wherein each section was assigned with an emotional probability of at least Y, and the sections belong to at most Z clusters of consecutive sections. The global score of the signal is preferably determined from part or all of the emotional sections and their scores. In a preferred alternative, the determination sets a score for the signal, based on all, or part of the emotional sections within the signal, and determines that an interaction is emotional if the score exceeds a certain threshold. In another preferred embodiment, the scoring can take into account additional data, such as spotted words, CTI events or the like. For example, if the emotional probability assigned to an interaction is lower than a threshold, but the word “aggravated” was spotted within the signal with a high certainty, the overall probability for emotion is increased. In another example, multiple hold and transfer events within an interaction can raise the probability for an interaction to be emotional If the method and apparatus should distinguish between multiple emotions, steps 222, 224 and 228 are performed emotion-wise, thus associating the certainty level with a specific emotion.

At step 230 the results, i.e., the global emotional score and preferably all sections indices and their associated emotional scores are output for purposes such as analysis, storage, playback or the like. Additional thresholds can be used at a later usage. For example, when issuing a report the user can set a threshold and ask to see retrieve the signals which were assigned an emotional probability exceeding a certain threshold. All mentioned thresholds, as well as additional ones, can be predetermined by a user or a supervisor of the apparatus, or dynamic in accordance with factors such as system capacity, system load, user requirements (false alarms vs. miss detect tolerance), or others. Either at step 222, 224 or at step 228, additional data, such as CTI events, spotted words, detected laughter or any other event, can be considered with the emotion probability score and increase, decrease or even null the probability score.

Referring now to FIG. 4, detailing the main step in the front-end preprocessing state 108 of FIG. 2 and 208 of FIG. 3. Front-end processing comprises the following steps: at step 304, a DC component, if present, is removed from the signal in order to avoid pitfalls when applying zero crossing functions in the time domain. The DC component is preferably removed using high pass filter. At step 308, the non-speech segments of the audio are detected and filtered in order to enable more accurate speech modeling in later steps. The removed non-speech segments include tones, music, background noise and other noises. At step 312 the signal is classified into three groups: silence, unvoiced speech (e.g., [sh], [s], [f] phonemes) and voiced speech (e.g., [aa], [ee] phonemes). Some features, pitch for example, are extracted only from the voiced sections while other features are extracted from the voiced and unvoiced sections.

At step 314, a speaker segmentation algorithm for segmenting multiple speakers in the recording is optionally executed. In call center environment, two speakers or more may be recorded on the same side of a recording channel, for example in cases such as an agent-to-agent call transfer, customer-to-customer handset transfer, other speaker's background speech, or IVR. Analyzing multiple speaker recordings may degrade the emotion detection algorithm accuracy, since the voice model determination steps 116 and 120 of FIG. 2 and 218 and 220 of FIG. 3 require a single-speaker input, so that the distance determination steps 122 of FIG. 2 and 222 of FIG. 3 can determine the differences between the reference and sections voice models of the same speaker. The speaker segmentation can be performed, for example by an unsupervised algorithm that iteratively clusters together sections of the speech that have the same statistical distribution of voice features.

The front-end processing might comprise additional steps, such as decompressing the signals according to the compression used in the specific environment. If one or more audio signals to be checked are received from an external source, and not form the environment on which the training phase took place, the preprocessing may include a speech compression and decompression with one of the protocols used in the environment in order to adapt the audio to the characteristics common in the environment. The preprocessing can further include low-quality sections removal or other processing that will enhance the quality of the audio.

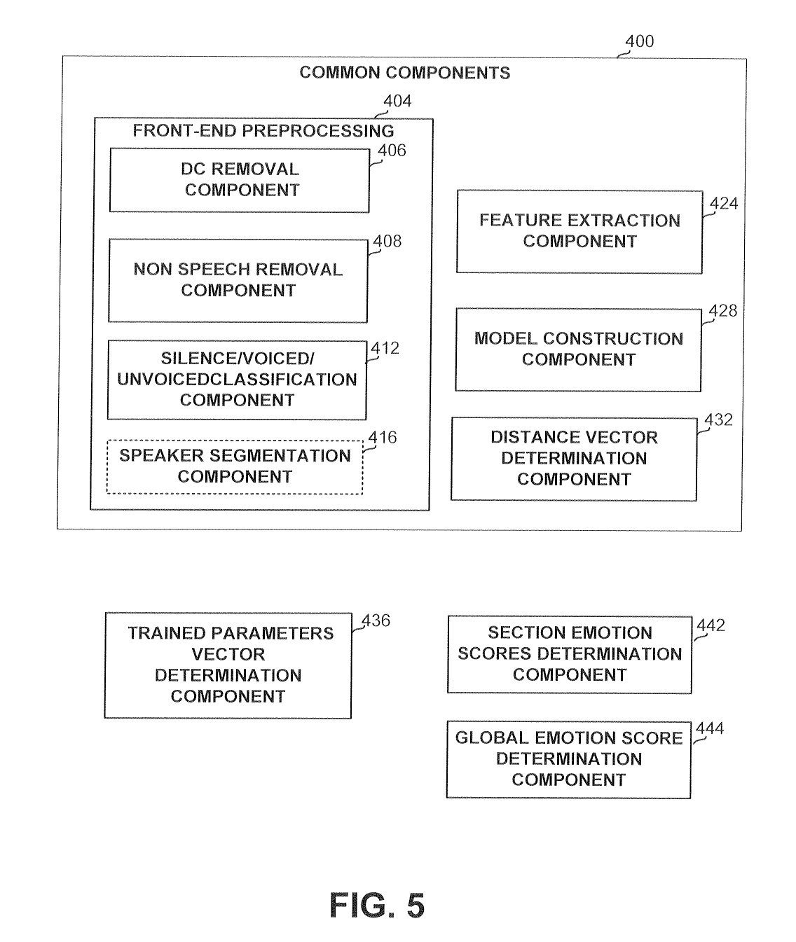

Referring now to FIG. 5, showing the main computing components used by emotion detection component 36 of FIG. 1, in accordance with the disclosed invention. Some of the components are common to the training phase and to the ongoing emotion detection phase, and are generally denoted by 400. Other components are used only during the training phase or only during the ongoing emotion detection phase. However, the components are not necessarily performed by the same computing platform, or even at the same site. Different instances of the common components can be located on multiple platforms and run independently. Common components 400 comprise front-end preprocessing components, denoted by 404 and additional components. Front-end preprocessing components 404 perform the steps associated with FIG. 4 above. DC removal component 406 performs DC removal step 304 of FIG. 4. Non speech removal component 408 performs non speech removal step 308 of FIG. 4. silence/voiced/unvoiced classification component 412 classifies the audio signal into silence, unvoiced segments and voiced segments, as detailed in association with silence/voiced/unvoiced classification step 312 of FIG. 4. Speaker segmentation component 416 extracts single-speaker segments of the recording, thus performing step 314 of FIG. 4. Common components 400 further comprises a feature extraction component 424, performing feature extraction from the audio signal as detailed in association with step 112 of FIG. 2 and step 212 of FIG. 3 above, and a model construction component 428 for constructing a statistical model for the voice from the multiplicity of feature vectors extracted by component 424. Yet another component of common components 400 is distance vector determination component 432 which determines the distance between a reference voice model constructed for an interaction, and a voice model of a section within the interaction. Using the distance between the voice model of each section and the reference voice model which represents the neutral state of the speaker, rather than the characteristics of the section itself, provides the speaker-independency of the disclosed method and apparatus. The method employed by distance determination component 432 is further detailed in association with step 122 of FIG. 2 and step 222 of FIG. 3. The computing components further comprise components that are unique to the training phase or to the ongoing phase. Trained parameters vector determination component 436 is active only during the training phase. Component 436 determines the trained parameters vector, as detailed in association with step 124 of FIG. 2 above. The components used only during the ongoing emotion detection phase comprise section emotion score determination component 442 which determines a score for the section, the score representing the probability that the speech within the section is conveying an emotional state of the speaker. The components used only during the ongoing emotion detection phase further comprise global emotion score determination component 444, which collects all of the section scores related to a certain recording, as output by section emotion score determination component 442, and combines them into a single probability that the speaker in the audio was in emotional state at some time during the interaction. Global emotion score determination component 444 preferably uses predetermined or dynamic thresholds as detailed in association with step 228 of FIG. 3 above.

The disclosed method and apparatus provide a novel method for detecting emotional states of a speaker in an audio recording. The method and apparatus are speaker-independent and do not rely on having an earlier voice sample of the speaker. The method and apparatus are fast, efficient, and adaptable for each specific environment. The method and apparatus can be installed and used in a variety of ways, on one or more computing platforms, as a client-server apparatus, as a web service or any other configuration.

People skilled in the art will appreciate the fact that multiple embodiments exist to various steps of the associated methods. Various feature and feature combinations can be extracted from the audio; various ways of constructing statistical models from multiple feature vectors can be employed; various distance determination algorithms may be used; and various methods and thresholds may be employed for combining multiple emotion scores wherein each score is associated with one section within a recording, into a global emotion score associated with the recording.

It will be appreciated by persons skilled in the art that the present invention is not limited to what has been particularly shown and described hereinabove. Rather the scope of the present invention is defined only by the claims which follow.

What is claimed is:

1. A method for detecting an at least one emotional state of an at least one speaker speaking in an at least one tested audio signal having a quality, the method comprising an emotion detection phase, the emotion detection phase comprising:
a feature extraction step for extracting at least two feature vectors, each feature vector extracted from an at least one frame within the at least one tested audio signal;
a first model construction step for constructing a reference voice model from at least two first feature vectors, said model representing the speaker's voice in neutral emotional state of the at least one speaker;
a second model construction step for constructing an at least one section voice model from at least two second feature vectors;
a distance determination step for determining an at least one distance between the reference voice model and the at least one section voice model; and
a section emotion score determination step for determining, by using the at least one distance, an at least one emotion score.

2. The method of claim 1 further comprising a global emotion score determination step for detecting an at least one emotional state of the at least one speaker speaking in the at least one tested audio signal based on the at least one emotion score.

3. The method of claim 1 further comprising a training phase, the training phase comprising:
a feature extraction step for extracting at least two feature vectors, each feature vector extracted from an at least one frame within an at least one training audio signal having a quality;
a first model construction step for constructing a reference voice model from at least two vectors;
a second model construction step for constructing an at least one section voice model from at least two feature vectors;
a distance determination step for determining an at least one distance between the reference voice model and the at least one section voice model; and
a parameters determination step for determining a trained parameter vector.

4. The method of claim 3 wherein the section emotion scores determination step of the emotion detecting phase uses the trained parameter vector determined by the parameters determination step of the training phase.

5. The method of claim 3 wherein the emotion detection phase or the training phase further comprises a front-end processing step for enhancing the quality of the at least one tested audio signal or the quality of the at least one training audio signal.

6. The method of claim 5 wherein the front-end processing step comprises a silence/voiced/unvoiced classification step for segmenting the at least one tested audio signal or the at least one training audio signal into silent, voiced and unvoiced sections.

7. The method of claim 5 wherein the front-end processing step comprises a speaker segmentation step for segmenting multiple speakers in the at least one tested audio signal or the at least one training audio signal.

8. The method of claim 5 wherein the front-end processing step comprises a compression step or a decompression step for compressing or decompressing the at least one tested audio signal or the at least one training audio signal.

9. The method of claim 1 wherein the method further associates the at least one emotional state found within the at least one tested audio signal with an emotion.

10. An apparatus for detecting an emotional state of an at least one speaker speaking in an at least one audio signal, the apparatus comprises:
a feature extraction component for extracting at least two feature vectors, each feature vector extracted from an at least one frame within the at least one audio signal;
a model construction component for constructing a model from at least two feature vectors;
a distance determination component for determining a distance between the two models; and
an emotion score determination component for determining, using said distance, an at least one emotion score for the at least one speaker within the at least one audio signal to be in an emotional state.

11. The apparatus of claim 10 further comprising a global emotion score determination component for detecting an at least one emotional state of the at least one speaker speaking in the at least one audio signal based on the at least one emotion score.

12. The apparatus of claim 10 further comprising a training parameter determination component for determining a trained parameter vector to be used by the emotion score determination component.

13. The apparatus of claim 10 further comprising a front-end processing component for enhancing the quality of the at least one audio signal.

14. The apparatus of claim 13 wherein the front-end processing step comprises a silence/voiced/unvoiced classification component for segmenting the at least one audio signal into silent, voiced, and unvoiced sections.

15. The apparatus of claim 13 where the front-end processing step comprises a speaker segmentation component for segmenting multiple speakers in the at least one audio signal.

16. The apparatus of claim 13 wherein the front-end processing component comprises a compression component or a decompression component for compressing or decompressing the at least one audio signal.

17. The apparatus of claim 10 wherein the emotional state is associated with an emotion.

18. A computer readable storage medium containing a set of instructions for a general purpose computer, the set of instructions comprising:
a feature extraction component for extracting at least two feature vectors, each feature vector extracted from an at least one frame within an at least one audio signal in which an at least one speaker is speaking;
a model construction component for constructing a model from at least two feature vectors;
a distance determination component for determining a distance between the two models; and
an emotion score determination component for determining, using said distance, an at least one emotion score for the at least one speaker within the at least one audio signal to be in an emotional state.
